(19) United States
(12) Patent Application Publication
(10) Pub. No.: US 2005/0122422 A1
(43) Pub. Date: Jun. 9, 2005

(54) Video camera synchronized infrared strobe inspection system

(76) Inventors: Edward M. Kent, Spencer, TN (US); Robert T. Curtis, McMinnville, TN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/730,507

(22) Filed: Dec. 8, 2003

(51) Int. Cl. H04N 5/222

(52) U.S. Cl. 348/371

(57) ABSTRACT

A system and method for capturing high-speed motion. A video camera and an infrared strobe light are connected to a video synchronization separator circuit. The video synchronization separator circuit fires the infrared strobe light as a result of receiving a signal from the video camera. The video synchronization separator circuit may be configured to fire the infrared strobe light after a settable delay period. Preferably, an infrared bandpass filter is employed over the lens of the video camera. A video recorder may be connected to the video camera. Preferably, the video recorder has the ability to play back in a single frame mode. A monitor may be connected to the video recorder. The video synchronization separator circuit is configured to extract a vertical synchronization pulse from the signal received from the video camera, and use said vertical synchronization pulse to provide a triggering signal to the infrared strobe light.

### BACKGROUND

This invention generally relates to high-speed camera systems, and more specifically relates to a method and device which uses an IR strobe to effectively freeze motion with a standard video camera.

There are many situations where it is desirable to take a photograph (i.e., obtain a still image) of something that is occurring at a very high rate of speed. For example, it may be desirable to monitor the metal chip flowing off a cutting insert inside of a CNC lathe. Some lathes have small waterproof cameras installed, but typically the pictures are blurry due to the high speed of the chip flow.

High-speed camera systems are available, but they are expensive (in some cases as high as $20,000) and are not feasible for use in some environments, such as in a CNC machine compartment. High-speed cameras are also typically quite large, and require high power light sources.

### OBJECTS AND SUMMARY

An object of an embodiment of the present invention is provide a method and system wherein an infrared strobe is used to effectively freeze motion with a standard video camera.

Another object of an embodiment of the present invention is to provide a method and system wherein a low cost video camera is used to capture high speed motion.

Briefly, and in accordance with at least one of the foregoing objects, embodiments of the present invention provide a system and method for capturing high-speed motion. A video camera and an infrared strobe light are connected to a video synchronization separator circuit. The video synchronization separator circuit fires the infrared strobe light as a result of receiving a signal from the video camera. The video synchronization separator circuit may be configured to fire the infrared strobe light after a settable delay period. Preferably, an infrared bandpass filter is employed over the lens of the video camera. A video recorder may be connected to the video camera. Preferably, the video recorder has the ability to play back in a single frame mode. A monitor may be connected to the video recorder. The video synchronization separator circuit is configured to extract a vertical synchronization pulse from the signal received from the video camera, and use said vertical synchronization pulse to provide a triggering signal to the infrared strobe light . . . .

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a block diagram of a video-capturing system which is in accordance with an embodiment of the present invention;

FIG. 2 is a block diagram of a synchronization circuit which is employed in the system shown in FIG. 1;

FIG. 3 is a circuit diagram of the synchronization circuit shown in FIG. 2; and

FIG. 4 is a flow chart which illustrates a method which is in accordance with an embodiment of the present invention.

### DESCRIPTION

While the present invention may be susceptible to embodiment in different forms, there are shown in the drawings, and herein will be described in detail, embodiments thereof with the understanding that the present description is to be considered an exemplification of the principles of the invention and is not intended to limit the invention to that as illustrated and described herein.

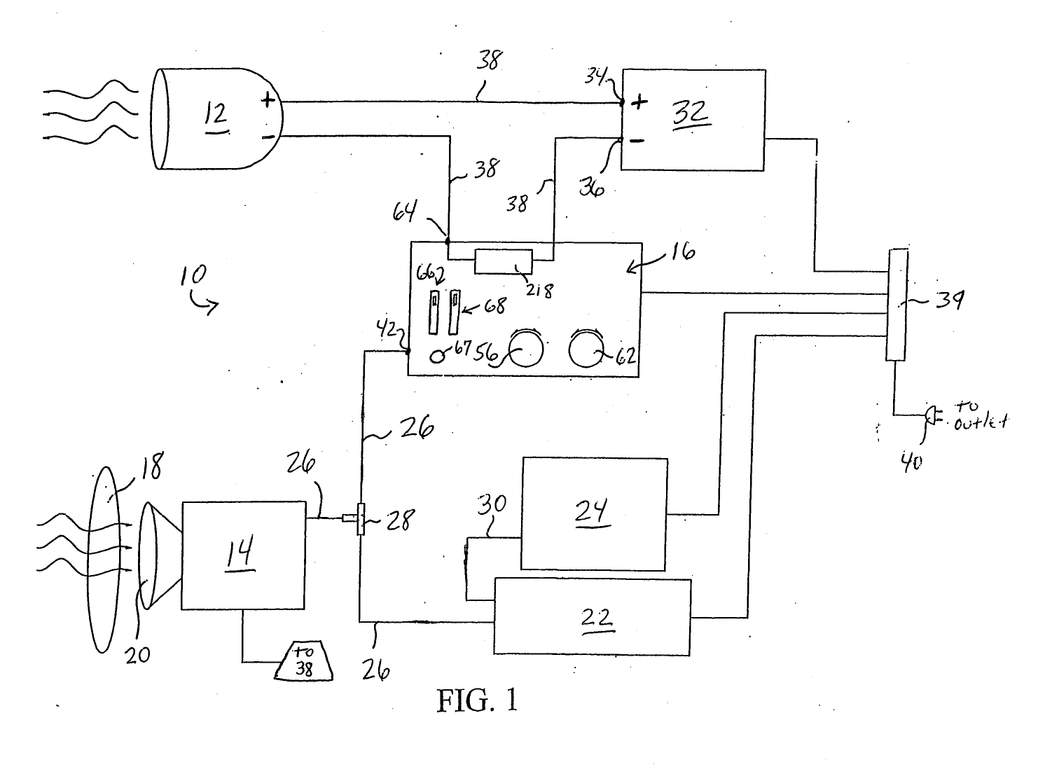

FIG. 1 illustrates a video-capturing system 10 which is in accordance with an embodiment of the present invention. The system 10 provides that an infrared strobe 12 is used to effectively freeze motion with a standard video camera 14. In other words, the system provides that a low cost video camera can be used to capture high speed motion.

As shown, the system 10 includes a video synchronization separator circuit 16 which is connected to a video camera 14 and an infrared strobe light 12. As will be described in more detail hereinbelow, the video synchronization separator circuit 16 is configured to fire the infrared strobe light 12 synchronized with a video signal received from the video camera 14.

The video camera 14 may be a conventional, low cost video camera. Preferably, an infrared bandpass filter 18 is employed over the lens 20 of the video camera 14. As such, the video camera 14 is unaffected by ambient light. The infrared strobe light 12 may be a light emitting diode (LED) strobe of short duration (such as approximately 100 microseconds).

Preferably, the video camera 14 is connected to a video cassette recorder 22. The video cassette recorder 22 may be conventional, but preferably it has the ability to play back in a single frame mode. The video cassette recorder 22 is preferably connected to a monitor 24, such as a television monitor. The video synchronization separator circuit 16, video camera 14 and video cassette recorder 22 may be interconnected via 75 ohm coaxial cable 26 and a t-connector 28. Additionally, a 75 ohm coaxial cable 30 may also connect the video cassette recorder 22 to the television monitor 24.

Preferably, a direct current power supply 32 is connected to the video synchronization separator circuit 16 as well as to the infrared strobe light 12. Specifically, the positive connector 34 of the power supply 32 is preferably connected to the infrared strobe light 12, and the negative connector 36 of the power supply 32 is preferably connected to the video synchronization separator circuit 16. The power supply 32 may be an FAK 50 Watt High Frequency Switching power supply, available from Kepco, Inc., 131-38 Sanford Ave., Flushing N.Y. 11352. The video synchronization separator circuit 16 is also connected to the infrared strobe light 12. The power supply 32, video synchronization separator circuit 16 and infrared strobe light 12 may all be interconnected via 16 AWG wire 38. The power supply 32, video synchronization separator circuit 16, television monitor 24, video cassette recorder 22 and video camera 14 may all be configured to be powered by 120 volts of alternating current (i.e., from a standard wall outlet in the United States). As such, as shown in FIG. 1, the power supply 32, video synchronization separator circuit 16, television monitor 24, video cassette recorder 22 and video camera 14 may all be connected to a power strip 39 which receives 120 volts of alternating current (such as through a plug 40 which is connected to a wall outlet).

The video synchronization separator circuit 16 is configured to turn on the infrared strobe light 12, thereby creating a short, high intensity flash. Since an infrared bandpass filter 18 is employed over the lens 20 of the video camera 14, only the short, infrared flash exposes the CCD array. The resulting video signal is then recorded onto the video cassette recorder 22 and played back in single frame mode. The flash causes the motion of the individual frame to be stopped. Due to the low frame rate of a standard video camera, the motion is not continuous, but with a repetitive process, all the action is captured in time.

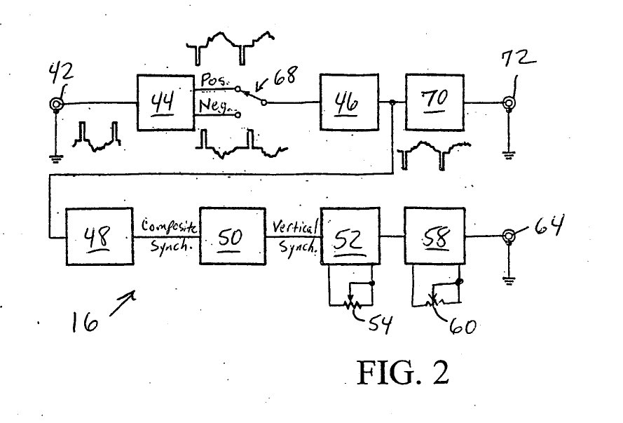

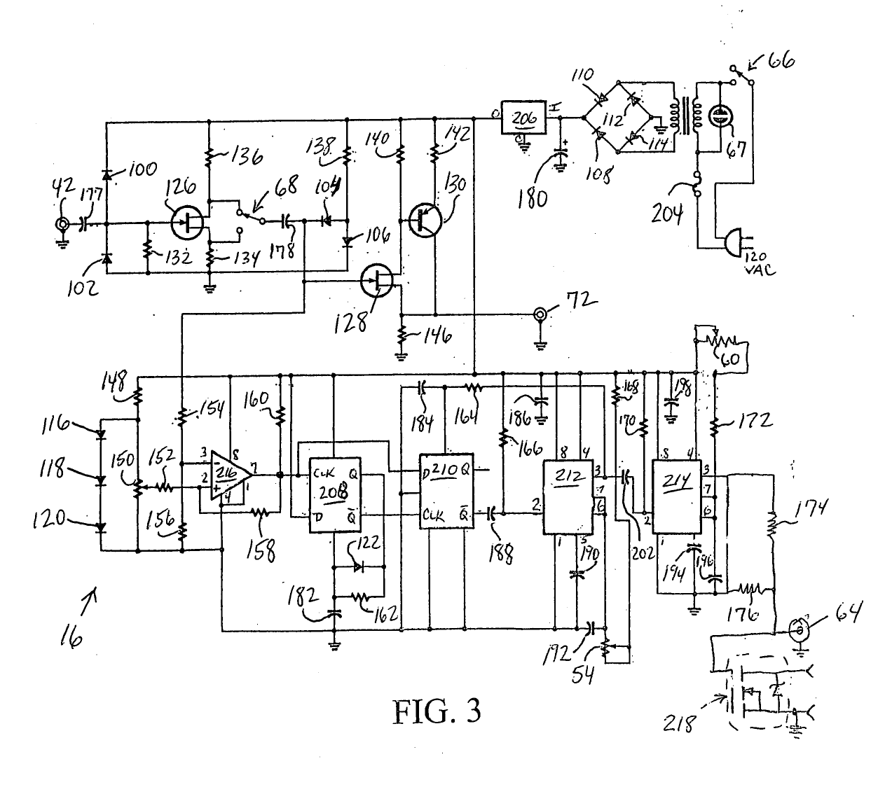

FIG. 2 shows the video synchronization separator circuit 16 as a block diagram. The basic concept of the video synchronization separator circuit is to extract a vertical synchronization pulse from a video signal (i.e., from the video camera) and use it to provide a triggering signal (i.e., to the infrared strobe light). As shown, the video synchronization separator circuit 16 includes a video input 42, a buffer phase shifter circuit 44, a clamp circuit 46, a synchronization separator 48, a vertical pulse separator 50, a variable delay single shot circuit 52 (the delay being adjustable viz-a-viz a variable resistor 54, which is preferably settable using a knob 56—see also FIG. 1), a variable pulse width single shot circuit 58 (the pulse width being adjustable viz-a-viz a variable resistor 60, which is preferably settable using a knob 62—see also FIG. 1), and a trigger output 64. The video synchronization separator circuit 16 preferably has a power switch 66 and red neon “power on” indicator light (see FIGS. 1 and 3), and may have a polarity switch 68 (primarily because, to date, video synchronization separator circuits have been used in association with oscilloscopes). Additionally, although not imperative to the present invention, the video synchronization separator circuit 16 may also include a buffer circuit 70 and a clamped video output 72 (again, primarily because, to date, video synchronization separator circuits have been used in association with oscilloscopes). As shown in FIG. 1, the video camera 14 is connected to the video input 42, and the infrared strobe light 14 is connected to the trigger output 64.

FIG. 3 is a circuit diagram of the video synchronization separator circuit 16. As shown, the synchronization separator circuit includes video input 42, clamped video output 72, trigger output 64, power on light 67, variable resistors 54, 60, diodes 100, 102, 104, 106, 108, 110, 112, 114, 116, 118, 120, 122, transistors 126, 128, 130, resistors 132, 134, 136, 140, 142, 146, 148, 150, 152, 154, 156, 158, 160, 162, 164, 166, 168, 170, 172, 174, 176, capacitors 177, 178, 180, 182, 184, 186, 188, 190, 192, 194, 196, 198, 202, fuse 204, integrated circuits 206, 208, 210, 212, 214, a differential comparator 216, and a power MOSFET transistor 218.

Here is a table of the preferred values for each of the components, wherein rated resistance is given in ohms and rated capacitance is given in Farads:

| Component number | Rating |
|---|---|
| 54 | 100k |
| 60 | 50k |
| 67 | NE1 |
| 100, 102, 108, 110, 112, 114 | 1N4001 |
| 104, 106, 116, 118, 120, 122 | 1N4148 |
| 126, 128 | 2N3823 |
| 130 | 2N3906 |
| 132, 156, 158 | 1 Meg |
| 134, 136, 140, 146, 154 | 1k |
| 138, 148, 160 | 4.7k |
| 142, 168 | 220 |
| 150 | 10k |
| 152, 166, 170 | 10k |
| 162, 172 | 2k |
| 164 | 20k |
| 174, 176 | 560 |
| 177, 178, 184, 186, 198 | 0.1 |
| 180 | 470 micro |
| 182 | 0.0047 |
| 188, 190, 194, 202 | 0.001 |
| 192 | 0.22 |
| 196 | 0.01 |
| 204 | 0.5 Amps |
| 206 | 7815 |
| 208, 210 | 4013 |
| 212, 214 | 555 |
| 216 | LM311 |
| 218 | IRLBA 1304/P |

Diodes 100 and 102 provide over-voltage protection for the gate of transistor 126, which is a simple phase splitter. The splitter is necessary because the video clamp 46 and synch separator sections 48 mst always receive a video signal with its synch pulses going negative. Switch 68 is used to select the appropriate polarity and send the signal onto the video clamp 46. The clamp 46 consist of capacitor 178, diodes 104, 106, and resistors 138, 154, 156. Capacitor 178 couples the video signal into the clamp circuit 46. When the video voltage goes negative during synch-pulse time, diode 104 is forward biased, and capacitor 104 quickly charges up to the peak value of the signal. As the signal swings positive, diode 104 is reverse biased and capacitor 104 must discharge through resistors 154, 156. The discharge current produces a positive bias, voltage across resistor 156 which is directly proportional to the peak voltage of the waveform.

The capacitor 178—resistor 156 time constant is quite long (i.e., 0.1 second) with respect to one horizontal time period. Because of that, the bias voltage remains essentially constant for the full period of the line. The effect of the bias is to force all of the sync pulse-tips to line up at the same level. Resistor 138 and diode 106 provide a +0.6-volt reference level for diode 104, which prevents the clamped signal from going below ground potential.

Transistors 128 and 130 form a wideband high-input-impedance buffer/amplifier. Differential comparator 216 separates the sync pulses from the video information. The bias voltage on pin 2, the non-inverting input of the differential comparator 216, is set by trimmer potentiometer 150. With the bias voltage properly set, the output (pin 7) will switch or change state only during the sync-pulse time, effectively stripping off the video and leaving only composite-sync signals.

From differential comparator 216, the composite sync goes to integrated circuits 208 and 210, which are both halves of a dual D-type CMOS flip-flop. That circuit separates the vertical-sync pulses from the horizontal by detecting the duty cycle change that occurs during the vertical-sync pulse time. Since differential comparator 216 is set up as an inverting comparator, the composite-sync pulses at its output are now positive-going. The rising edge of each horizontal-sync pulse clocks the input (pin 11) of integrated circuit 208. Since the D input is tied to a high logic-level, those rising edges clock a high level into the Q output and a low logic-level into the Q-inverse output. When the Q output goes high, capacitor 182 begins charging up through resistor 162. Diode 122 is reverse biased at this time and has no effect.

After about 10 microseconds, the voltage across capacitor 182, and thus the voltage at pin 10 (RESET) will be high enough to reset the flip-flop 208, forcing the Q output low again. That allows capacitor 182 to discharge rapidly through diode 122, bringing the sequence to an end. The result is that flip flop 208 is actually a one-shot with a period of approximately 10 microseconds—about twice as long as a standard horizontal-sync pulse.

The Q-inverse output of flip flop 208 drives the CLOCK input of flip flop 210. That means that the rising edge seen at the CLOCK input corresponds to the end of the 10-microsecond time period. The D input of flip flop 210 is not tied high, and is instead connected to the composite-sync output of differential comparator 216. As a result, whenever flip flop 208 is triggered by the horizontal-sync pulses, the D input of flip flop 210 will be low when the rising edge occurs at its clock input. Since the D input of flip flop 210 is low when the clock pulse occurs, no change takes place at the Q-inverse output.

The duty cycle of a vertical-sync pulse is much wider than that of the horizontal pulses. Therefore, when a vertical-sync pulse triggers flip flop 208, the D input of flip flop 210 will still be high at the end of the 10-microsecond period. Since the D input is at a high logic-level when the clock pulse occurs, Q-inverse of flip flop 210 will go low. The Q-inverse output will stay low as long as the duty cycle seen at the D input is longer than that of a horizontal-sync pulse.

So, at the Q-inverse output of flip flop 210, there will be a negative-going pulse that corresponds to vertical sync. The falling edge of that pulse is differentiated by capacitor 188 and resistor 166 and is used to trigger the delay one-shot 212. With the DELAY potentiometer 54 at minimum resistance, the delay one-shot 212 has a time period of 16.5 milliseconds—just about the same length of time as one complete field. With resistor 54 at maximum resistance, the time period is 40 milliseconds, which is equivalent to approximately 2½ fields.

At the end of the delay one-shot's (212's) time period, wherever it might be set, the output at pin 3 goes low. This edge is differentiated by capacitor 202 and resistor 170 and used to trigger the last one-shot 214. The period of that mono-stable is fixed at 100 microseconds. The pulse is routed to trigger output 64 and used to trigger the infrared strobe light 12.

Resistor 164 and capacitor 184 help reduce jitter on long delays. A slightly delayed version of the DELAY one-shot's output is applied to the RESET input (pin 4) of flip flop 210. That guarantees that no spurious pulses will appear at its output until well after the delay period. A minimum time delay milliseconds may be used to ensure that the infrared strobe light 12 is not triggered on consecutive fields. If that were allowed to happen, images may become super-imposed on one another.

The video synchronization separator circuit 16 may be provided as a printed-circuit board, or may be built on a perforated construction board using point-to-point wiring.

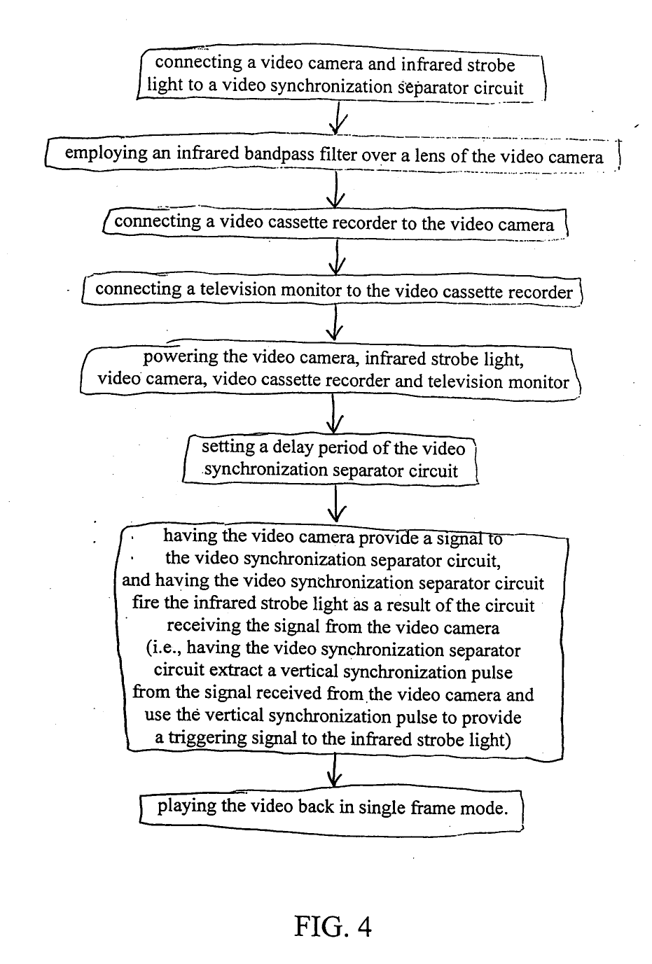

FIG. 4 illustrates a method of using the system shown in FIG. 1, where the method is in accordance with an embodiment of the present invention. In light of the foregoing description, FIG. 4 is self-explanatory.

While embodiments of the present invention are shown and described, it is envisioned that those skilled in the art may devise various modifications of the present invention without departing from the spirit and scope of the disclosure. For example, while the video camera, video cassette recorder and television monitor are shown and described as being three separate components, a single unit, digital camcorder with LCD display can be used in place of the video camera, video cassette recorder and television monitor. In fact, such a digital camcorder can be designed to include the video synchronization separator circuit and infrared strobe flash therein, in which case a single unit, all purpose device would be provided to include all the functionality illustrated in FIG. 1.

1. A system for capturing high-speed motion, said system comprising: a video camera; an infrared strobe light; a circuit connected to said video camera and said infrared strobe light, said circuit configured to fire said infrared strobe light as a result of receiving a signal from said video camera.

2. A system as recited in claim 1, wherein said circuit is configured to fire said infrared strobe light as a result of receiving said signal from said video camera, after a delay period.

3. A system as recited in claim 2, wherein said circuit is configured such that said delay period is settable by a user.

4. A system as recited in claim 1, further comprising an infrared bandpass filter over a lens of said video camera.

5. A system as recited in claim 1, wherein said infrared strobe light comprises a light emitting diode (LED) strobe.

6. A system as recited in claim 1, further comprising a video recorder connected to said video camera.

7. A system as recited in claim 6, wherein the video recorder comprises a video cassette recorder.

8. A system as recited in claim 6, wherein said video recorder has the ability to play back in a single frame mode.

9. A system as recited in claim 6, further comprising a monitor connected to said video recorder.

10. A system as recited in claim 1, wherein said circuit is configured to extract a vertical synchronization pulse from the signal received from said video camera and use said vertical synchronization pulse to provide a triggering signal to said infrared strobe light.

11. A system as recited in claim 10, wherein said circuit comprises a video input, a buffer phase shifter circuit connected to said video input, a clamp circuit connected to said buffer phase shifter circuit, a synchronization separator connected to said clamp circuit, a vertical pulse separator connected to said synchronization separator, a variable delay single shot circuit connected to said vertical pulse separator, a variable pulse width single shot circuit connected to said variable delay single shot circuit, and a trigger output connected to said variable pulse width single shot circuit.

12. A method of using a system comprising a video camera, infrared strobe light, and a circuit to capture high-speed motion, said method comprising: connecting the video camera and the infrared strobe light to the circuit; powering the video camera, infrared strobe light and video camera; having the video camera provide a signal to the circuit; and having the circuit fire the infrared strobe light as a result of the circuit receiving the signal from the video camera; and playing the video back.

13. A method as recited in claim 12, wherein the step of having the circuit fire the infrared strobe light comprises having the circuit wait through a delay period before firing the infrared strobe light.

14. A method as recited in claim 13, further comprising setting the delay period.

15. A method as recited in claim 12, further comprising employing an infrared bandpass filter over a lens of the video camera.

16. A method as recited in claim 12, further comprising connecting a video recorder to the video camera.

17. A method as recited in claim 12, further comprising connecting a video cassette recorder to the video camera.

18. A method as recited in claim 16, further comprising connecting a monitor to the video recorder.

19. A method as recited in claim 12, further comprising extracting a vertical synchronization pulse from the signal received from the video camera and using the vertical synchronization pulse to provide a triggering signal to the infrared strobe light.
